(19) United States
(12) Patent Application Publication
(10) Pub. No.: US 2014/0331942 A1
(43) Pub. Date: Nov. 13, 2014

(54) Smart Electronic Pet Collar System for training and tracking health, location, and accurate activity levels of pets

(71) Applicant: Joshua Sarazyn, San Jose, CA (US)

(72) Inventor: Joshua Sarazyn, San Jose, CA (US)

(21) Appl. No.: 13/889,652

(22) Filed: May 8, 2013

(51) Int. Cl. A01K 29/00; A01K 27/00

(52) U.S. Cl. CPC A01K 29/005; A01K 27/001
USPC 119/719; 119/859

(57) ABSTRACT

This feedback collar (“FC”) is an all-inclusive training, health and accurate activity tracking unit for pets that directly pairs with a pet owner's smart phone, tablet, or other computer-like device that acts as a primary logging unit (“PLU”) for storing, accessing and managing data. The FC utilizes an array of sensors, radios and transmitters for logging and communicating information between one or more FCs and one or more PLUs. Utilizing the FC as a part of a smart electronic pet collar system (“SEPCS”), the owner will be able to access a history of the FC data from their phone, upload the data to a centralized web server, and share the data with other owner's.

### FIELD OF INVENTION

The present invention relates to managing pet health, training, and activity tracking More specifically, the utilization of an FC comprised of electronic sensors, data storage, and the ability to log, track and share this information with a PLU.

### BACKGROUND OF INVENTION

The invention relates to a system for logging and tracking the activity, training, and health metrics of a pet.

As technology has advanced, our society has become more interested in utilizing technology to assist with making our lives easier, healthier, and more fun/interactive. Conventional technology has disclosed methods to help us live healthier, more fulfilling lives via tools such as Bodymedia, FitBit, and similar devices. These tools have benefited humans in helping them achieve fitness goals and become more physically fit by logging pertinent health data for the user while putting a fun/interactive spin on fitness. Accordingly, similar methods could be utilized to help keep our pets healthier while simultaneously assisting us in training them to be better “animal” citizens.

Prior art has utilized an electronic means for training and controlling animal behavior for the majority of the past century. Collars that utilized radio communication have existed since the middle of the 20^{th} century, and devices that refine the accuracy and range of that control have been produced since then. More advanced devices have allowed both positive and negative reinforcement cues to be remotely issued via wireless communication to a collar.

More recent prior art has enabled users to track basic activity levels of pets for the purpose of health monitoring (e.g., http://www.fujitsu.com/global/news/pr/archives/month/2012/20120514-02.html). The Fujitsu system will work like a pedometer to track dog activity levels. Additionally, the sensor will track ambient temperature and shivering. Similarily, the FitBark system (www.fitbark.com) is capable of tracking basic activity levels and interacting with a smartphone/mobile device. The Greengoose system merely measures activity level or movement of whatever it is attached to (e.g., http://www.greengoose.com.learn). These prior art devices/systems may hook the system/sensors to a dog collar.

### BRIEF SUMMARY OF THE INVENTION

In spite of the foregoing, the prior art and the literature fail to provide a means for tracking accurate activity levels of a pet derived from the logging of location-tracking data. Coupled with data derived from an accelerometer or pedometer-like sensor of the present invention's SEPCS, owners are able to gain a much clearer picture of a pet's activity. Through the use of an application or software (“APP”) for their PLU or PC, owners will be able to compare and log sensor data over time to gain an understanding of their pet's overall health, well-being, and training progress.

By utilizing the wireless communication (“WC”) means between the FC and PLU, a direct wireless connection also allows owners to assert positive or negative reinforcement commands to their pet for the purpose of training by utilizing the capabilities built into the APP and feedback mechanisms built into the FC or as a part of an accessory add-on.

The owner's PLU coupled with the functionality of the APP enable the owner to log and compare data over time to track progress of their pet's health, training, and well-being. The SEPCS also enables an owner to selectively communicate and share data with other owners who have access to the SEPCS network.

### DESCRIPTION OF THE DRAWINGS

The construction designed to carry out the invention will herein after be described, together with other features thereof.

The invention will be more readily understood from a reading of the following specification and by reference to the included drawings forming a part thereof, wherein an example of the invention is shown and wherein:

FIG. 1A is a schematic/exploded view of the FC/FCA;

FIG. 1B is a view of the FC/FCA attached to a standard/off-the-shelf pet collar;

FIG. 1C is a view of the FC/FCA attached to a collar that has been included as part of the SEPCS;

FIG. 2A is an illustration of the WC capabilities between the owner's PLU and the FC;

FIG. 2B is an illustration of the WC capabilities between the owner's PC and the FC;

FIG. 3A demonstrates how the owner will interact with the APP in order to view and track health and training metrics on their PLU;

FIG. 3B is a close-up of the owner's PLU;

FIG. 3C demonstrates how the owner will interact with the APP in order to view and track health and training metrics on their PC;

FIG. 4 demonstrates how the owner will be able to interact with the SEPCS network through the website from their PC;

FIG. 5A demonstrates how multiple owners, with independent PLUs and each owner possessing one or more of a plurality of FCs, can be automatically alerted of fellow SEPCS owners within a specified distance/range of them based on SEPCS location data collected by owner's respective PLUs. For example, several owners may be within proximity of one another at the same dog park and choose to share data via the SEPCS network;

FIG. 5B is a close up of the PLU(s) that are shown in FIG. 5A;

FIG. 6A illustrates an example of a path traveled by a pet while the FC is worn and recording location-tracking data;

FIG. 6B demonstrates an owner viewing the metrics recorded in FIG. 6A overlaid on a map through the APP after syncing with their PLU;

FIG. 7 illustrates the basic movement tracking function where the collar utilizes the accelerometer or pedometer-like sensor to track pet movement when GPS is unavailable or not activated;

FIG. 8A illustrates an owner creating a sustained WC between the FC and PLU in order to use the collar for providing positive or negative feedback to the pet while training;

FIG. 8B depicts the APP GUI on the owner's PLU while interacting as demonstrated in FIG. 8A;

FIG. 9A through 15C illustrate a method for (FIG. 9A through 9C) and an array of (FIG. 10A through 15C) potential accessory add-ons that would be capable of piggybacking on the main FC to provide an owner with additional means for interacting with or recording training and health metrics of their pet. These represent potential examples, though accessory add-ons would not be limited to this selection.

### DEFINITIONS, ACRONYMS AND GLOSSARY OF TERMS

Owner(s) as used herein represents a person or group who owns a pet and/or a person or group who is/are placed in charge of a pet and/or a person or group who has an interest in the health, well-being, or training progress of a pet.

Pet as used herein primarily represents a dog, but aspects of this invention can be applied to other domestic pets, e.g., cats. The feedback collar would be worn by the pet on a regular basis in order to track the constant health, activity and overall well-being of an owner's pet.

FC/FCA as used herein is an abbreviation for Feedback Collar/Feedback Collar Attachment (used interchangeably).

PLU as used herein is an abbreviation for Primary Logging Unit.

SEPCS as used herein is an abbreviation for Smart Electronic Pet Collar System.

APP as used herein is an abbreviation for Application; which represents the SEPCS Application or SEPCS Software program which an owner can use through their Primary Logging Unit or Personal Computer, respectively.

WC as used herein is an abbreviation for Wireless Communication.

GPS as used herein is an abbreviation for the Global Positioning System, or global positioning satellite network. The Global Positioning System is a space-based satellite navigation system that can provide location information in all weather conditions, anywhere on or near the Earth's surface where there is an unobstructed line of sight to sufficient GPS satellites in the global positioning satellite network.

Battery as used herein refers to a power supply to provide power to all components included within the feedback collar.

Brain as used herein refers to a 6^{th} electronic means that provides the processing ability allowing the feedback collar and all components contained therein to function as intended.

GPS Chipset(s) as used herein refers to a component that represents an example of a 1^{st} electronic means and/or 2^{nd} electronic means, which enables a connection to the GPS.

LOC1 as used herein refers to the GPS location of one or more of a plurality of feedback collars determined using the 1^{st} electronic means, such as a GPS chip.

LOC2 as used herein refers to the GPS location of one or more of a plurality of primary logging units determined using the 2^{nd} electronic means, such as a GPS chip.

BM as used herein is an abbreviation for recording the basic movement of the feedback collar by means of the 3^{rd} electronic means, such as an accelerometer or pedometer-like sensor.

Storage as used herein refers to a 7^{th} electronic means that provides the feedback collar with a means to store the data metrics recorded from the various sensors and accessories.

Speaker as used herein refers to a speaker contained within the feedback collar capable of sonic to ultrasonic outputs in order to provide both the owner and pet a means of feedback.

Port as used herein refers to a means to connect a cable for recharging the feedback collar, as well as acting as a means to connect accessory add-ons to the collar for increased functionality.

PC as used herein is an abbreviation for personal computer.

LED(s) as used herein refers to one or more light emitting diode(s) contained in the feedback collar to provide feedback related to current status including but not limited to: battery levels, connectivity of Bluetooth, activation of GPS.

Button as used herein refers to a button on the feedback collar that enables interactions for functions including but not limited to functions such as turning the device on and off.

Metrics as used herein refers to the logged data the feedback collar records from its included sensors, which can comprise zero or more accessory add-ons, pertaining to activity, health and training of the pet.

TLT as used herein refers to a tension leash trainer accessory add-on.

VIB as used herein refers to a vibration feedback accessory add-on.

Shock as used herein refers to a shock feedback accessory add-on.

TH as used herein refers to a training helper accessory add-on.

THU as used herein refers to a training helper accessory add-on unit accompanied by zero or any number of secondary training sensor(s) and accompanying cable(s).

WL as used herein refers to an accessory add-on that allows an owner wireless leash functionality.

Sprayer as used herein refers to a pheromone and/or other positive or negatively correcting sprayer accessory add-on.

Cue as used herein refers to a signal that the owner has trained their pet to interpret as either positive or negative feedback to praise or correct their current actions, respectively.

Client(s) as used herein refers to owner(s) and their respective pet(s).

### DETAILED DESCRIPTION OF A PREFERRED EMBODIMENT

These detailed descriptions and representations are the means used to most effectively create the invention herein described.

### Preferred Embodiment

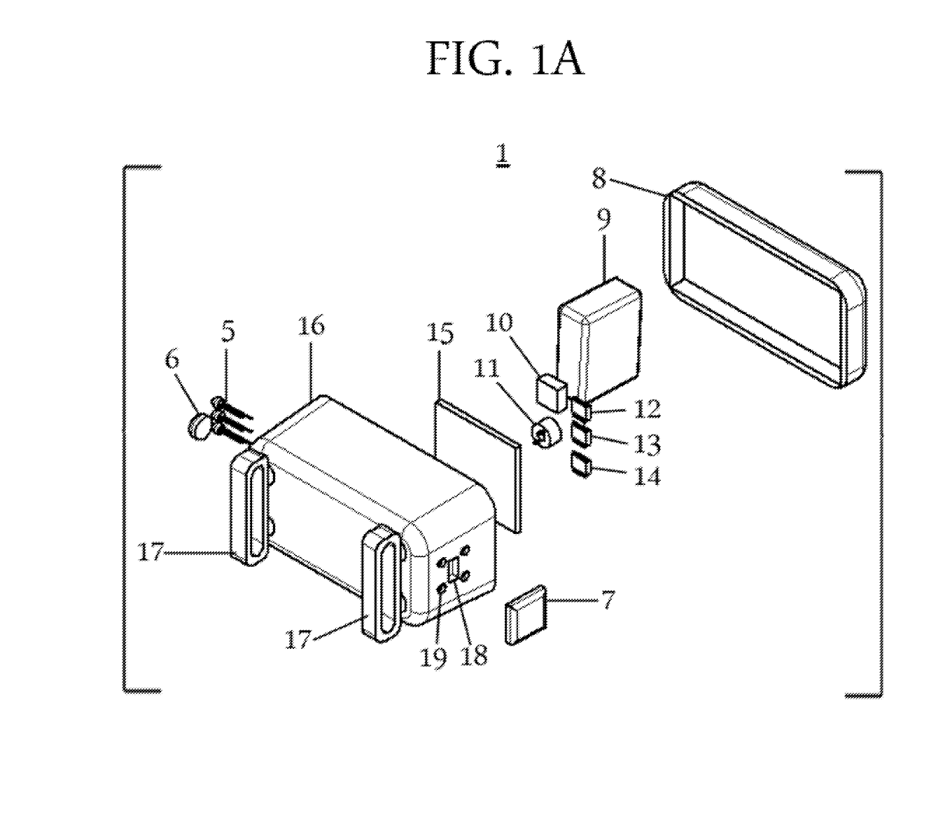

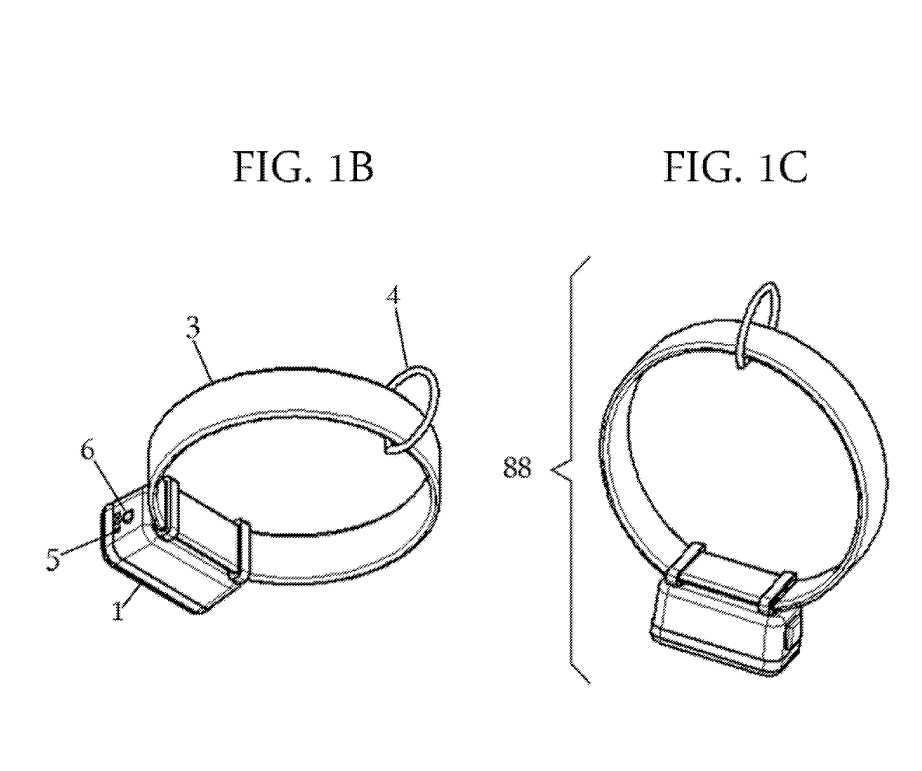

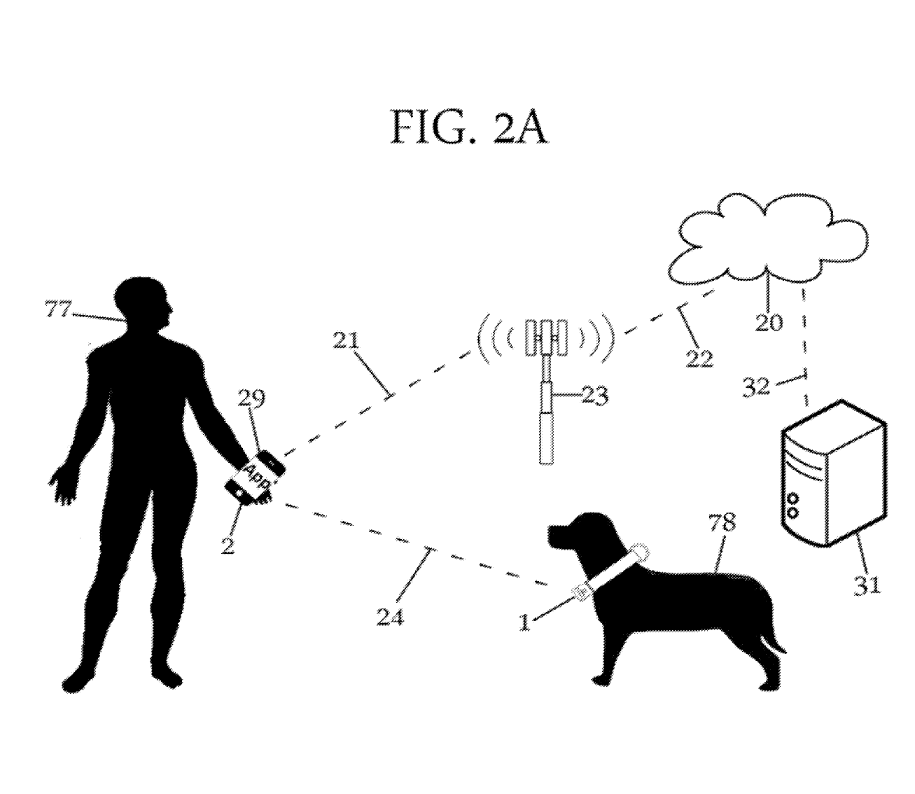

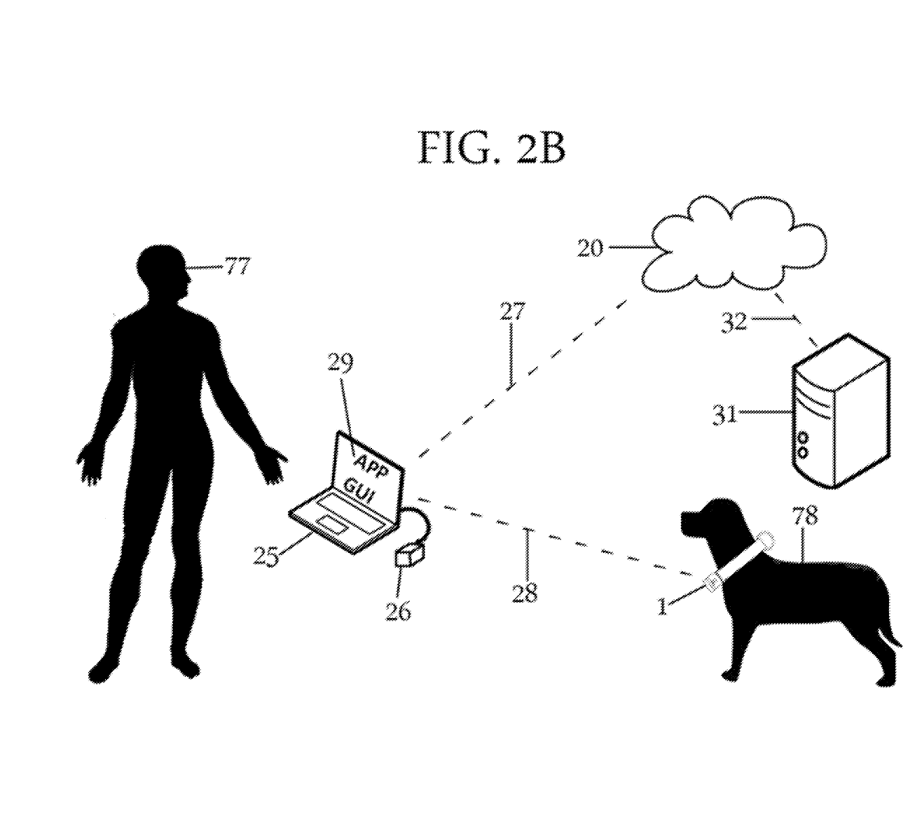

Referring to the drawings, FIG. 1A depicts a version of the feedback collar (“FC”) attachment (“FCA”) which comprises feedback electronics/devices. Herein “FC” is used to refer to either a collar that has feedback electronics/devices integrally formed into a collar (e.g., as shown in FIG. 1C) or to a standard/off-the-shelf pet collar that has feedback electronics/devices attached to the standard/off-the-shelf pet collar (e.g., as shown in FIG. 1B). Further, the FCA 1 comprises the assembly containing the feedback electronics/devices as depicted as an exploded view in FIG. 1A. The FCA 1 is comprised of an array of components including a bottom casing 16 that provides an attachment means 17 to interface with a standard/off-the-shelf collar 3 (e.g., as shown in FIG. 1B) or a means for connecting to an included collar (e.g., as shown in FIG. 1C); a Battery 9 to provide power to the FCA 1; a 6^{th} electronic means (“Brain”) 15 depicted as a main circuit board including but not limited to the components (e.g., see items 10-14) necessary to provide the capability of processing all information gathered by the internal sensors as described herein; a 1^{st} electronic means 13 capable of triangulating 1^{st} location (“LOC1”) of the FC through means utilizing existing GPS infrastructure; a 4^{th} electronic means 14 capable of creating a periodic or sustained WC between the FC and an owner's PLU (e.g., see PLU 2 as shown in FIG. 2A); a 3^{rd} electronic means 10 capable of recording basic movement (“BM”) such as an accelerometer or pedometer-like sensor; a 7^{th} electronic means (“Storage”) 12 that provides a means of storing the metrics gathered and interpreted by the FC/FCA in an encrypted format until a time when the owner can synchronize the FC with their PLU 2; Speaker 11 capable of outputting audio in the range of normal human hearing to ultrasonic levels (at which some pets can still hear); a connection Port 18 and female accessory attachment interface 19 that will act as a method for charging the Battery as well as a means for attaching accessory add-ons; a cover 7 that connects to the female accessory attachment interface 19 that will seal the FC's connection Port 18 when not utilizing accessory add-ons or charging; one or more LED indicator(s) 5 to demonstrate (including but not limited to): Battery power level, connection between FC and PLU, enabled/connected 1^{st} electronic means; one or more Button(s) 6 to interact with the FC for purposes (including but not limited to) of: turning the FC on/off, syncing the FC with the PLU. The top cover 8 will connect to the FC/FCA bottom case 16 in a way that the FC will be water/dust resistant or waterproof as found suitable in the art in conditions normally experienced by pets in order to assure that the FC 1 will not lose functionality through normal daily use. Additionally, FIG. 1B demonstrates how the FCA 1 will attach to a standard pet collar 3 depicted as containing a standard leash attachment 4, and FIG. 1C depicts The FC attached to an included collar 88.

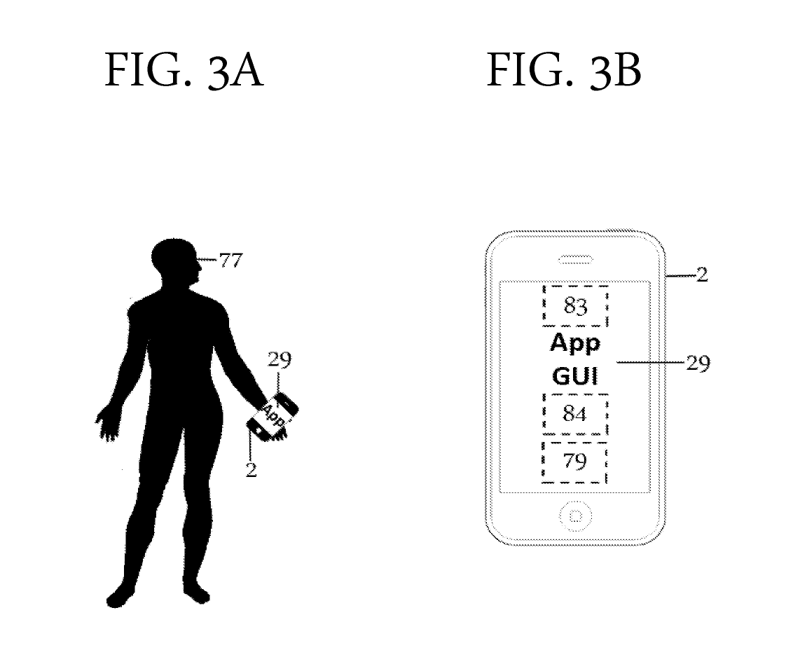

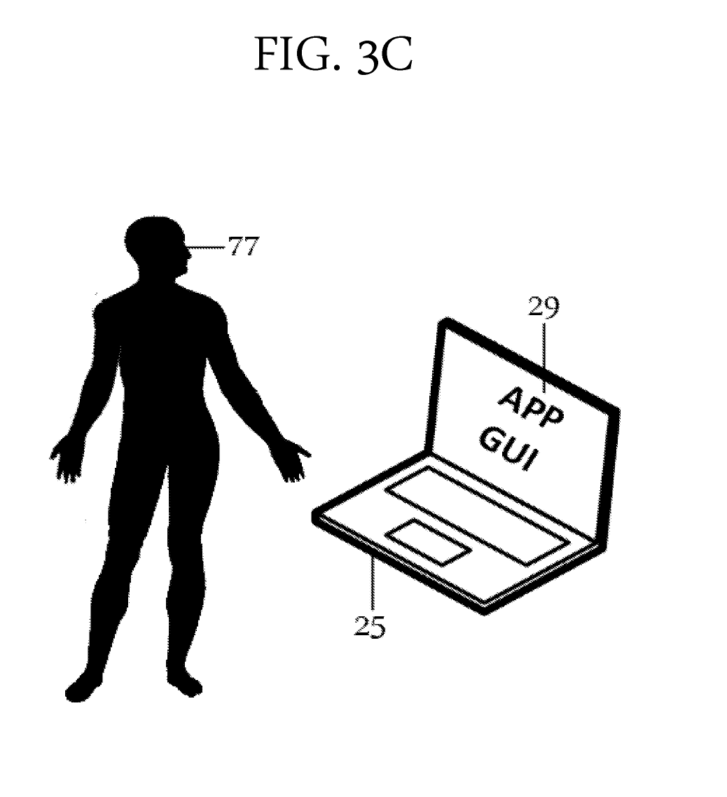

FIG. 2A and 2B demonstrate two methods with which the owner 77 can make a WC 24 to their pet's 78 FC/FCA 1. In FIG. 2A, the owner 77 is connecting their PLU 2 to the FCA 1 utilizing the 4^{th} electronic means 14 (i.e., see component 14 as shown in FIG. 1A) within the FC/FCA 1 and the 5^{th} electronic means 83 (e.g., see component 83 as shown in FIG. 3B) contained within the PLU 2 utilizing the WC capabilities 24. Once the owner has established a WC 24 to the FC 1 with their PLU 2, the owner 77 can use the APP 29 to retrieve the metrics that the FC's 1 Brain has logged in the storage since the last time the owner retrieved the metrics. After retrieving said metrics, the owner 77 can upload the information utilizing their WC 21 to the cellular tower infrastructure 23 which can then communicate 22 that information through the Internet 20 where it can then be communicated 32 to the SEPCS Server 31. Additionally, if an owner 77 does not possess a PLU 2, or chose not to use a PLU 2 at a given point in time, FIG. 2B depicts a WC 28 to their pet's 78 FC 1 through the 4^{th} electronic means and a USB accessory 26 that plugs into their personal computer (“PC”) 25. Once the owner has connected to the FC 1 with their PC 25, the owner can use the APP 29 to retrieve the metrics that the FC's 1 Brain has logged in the Storage since the last time the owner retrieved the metrics as well as utilize an existing connection 27 to upload the metrics to the SEPCS network through the Internet 20 where it can then be communicated 32 to the SEPCS Server 31.

FIG. 3A depicts an owner's 77 interaction with the APP 29 through the use of their PLU 2, and FIG. 3C depicts an owner's 77 interaction with the APP 29 through use of their PC 25. FIG. 3B is a close-up of the PLU 2 running the APP 29; additionally FIG. 3B depicts the 5^{th} electronic means 83 which is a Bluetooth radio or equivalent, the 2^{nd} electronic means 79 which is a GPS Chipset or equivalent, and the 8^{th} electronic means 84 which is an electronic storage means or equivalent, all three of which components are commonly found in PLU(s).

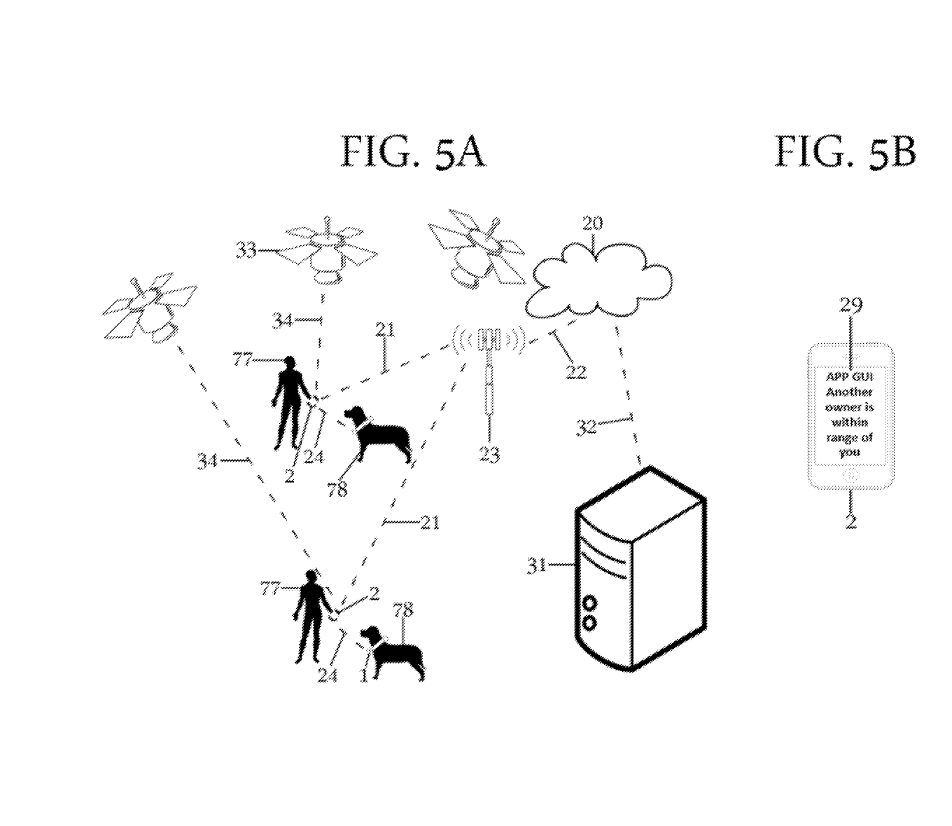

The APP 29 will allow the owner 77 to review logged metrics in the form of charts, graphs or the like in order to view the pet's progress over time. Additionally, it will be the gateway to adjusting any settings and interacting remotely with the FC, as well as a method for enabling or disabling sharing of LOC2 data with other owners 77 (see more information in paragraph 0063 pertaining to FIG. 5A and 5B). The APP 29 will possess the capability of enabling or disabling alerts to the owner 77 when a fellow owner 77 who they are connected to in the SEPCS network and whose LOC2 sharing is activated has returned to a designated proximity of the SEPCS, such as the area of a dog park where the owners' 77 meet. This APP 29 allows the owners 77 returning to the park or other meeting location to understand when other owners 77 are present at the park at the same time in order for their pets to play together again (see more information in paragraph 0063 pertaining to FIG. 5A and 5B). The APP 29 may also enable integration with the PLU 2 or PC's 25 calendar, and allow the owner 77 to easily activate and deactivate reminders for themselves for various activities, including but not limited to: walking their pet; practicing training techniques; scheduling veterinary appointments; and/or brushing their pet's teeth. Similarly, the APP 29 will allow the owner 77 to record instances of performing any of these or similar actions that are not metrics already automatically or otherwise already recorded by the FC.

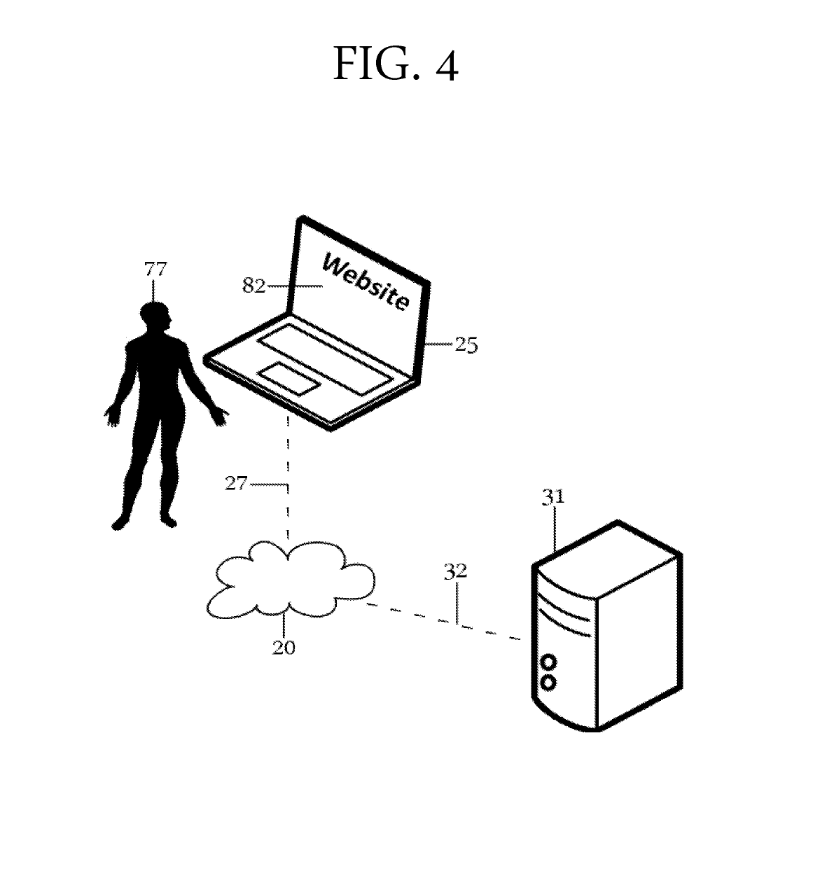

FIG. 4 demonstrates the owner 77 accessing the website 82 tied to the SEPCS network. The PC 25 will access the FC's metrics by utilizing an existing connection 27 to the Internet 20 which can connect 32 to the SEPCS server 31 that will act as a backup of owners' 77 metrics. If an owner 77 were to ever lose data on an owner's 77 respective PLU and/or PC 25, the owner 77 could provide a secure login and retrieve the latest back up of their pet's metrics. The SEPCS server 32 will be a platform for the website, providing respective owners 77 an additional method for secure login access to their pet's metrics to analyze the changes over time. The website 82 will also allow owners 77 to set up a profile for their pet, share their pet's information and metrics, communicate with other owners, and/or participate in an interactive game that provides them with points, goals, accomplishments, etc. which can be earned over time through the uploading of additional metrics. I.e., the interaction and/or games enabled via the SEPCS network enables friendly interaction amongst pets and/or owners 77 within the SEPCS network. This interaction through the SEPCS enables more healthy pets and a more fulfilling/enjoyable owner 77 experience through bonding and social interaction.

FIG. 5A demonstrates an instance when more than one of the owners 77 in the SEPCS network are utilizing their PLUs 2 connected 24 to their respective FCs 1 being worn by their respective pets 78 within a close proximity to each other, such as at the same park. If more than one owner's 77 PLUs 2 have their 2^{nd} electronic means 79 (e.g., see component 79 in FIG. 3B) enabled to determine their individual LOC2 by communicating 34 with the existing GPS 33, while their PLUs 2 maintain a data connection 21 to the cellular network 23 which in turn communicates 22 to the Internet 20, which allows a connection 32 with the SEPCS server 31 while they are within a set proximity of each other as well as have their LOC2 sharing enabled, then each respective owner 77 will receive an alert of the other's presence through the APP 29 (FIG. 5B demonstrates the PLU 2 alerting one or more owners 77 through the APP 29). This could be utilized for meeting like-minded owners 77, or for finding friends and competition on the website within the SEPCS network.

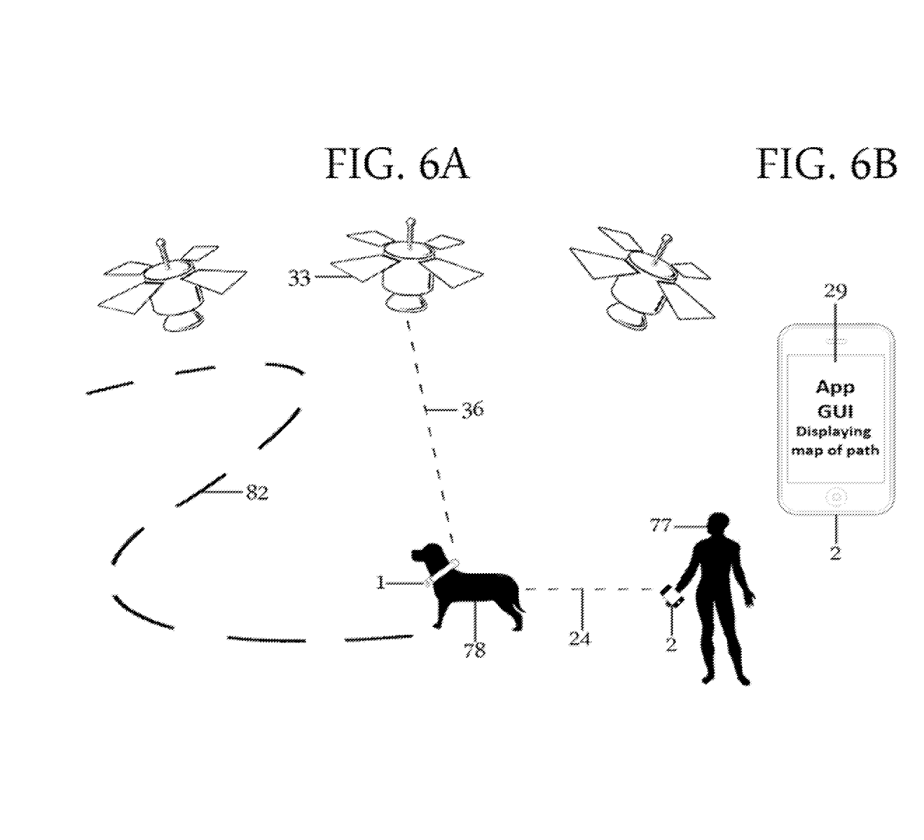

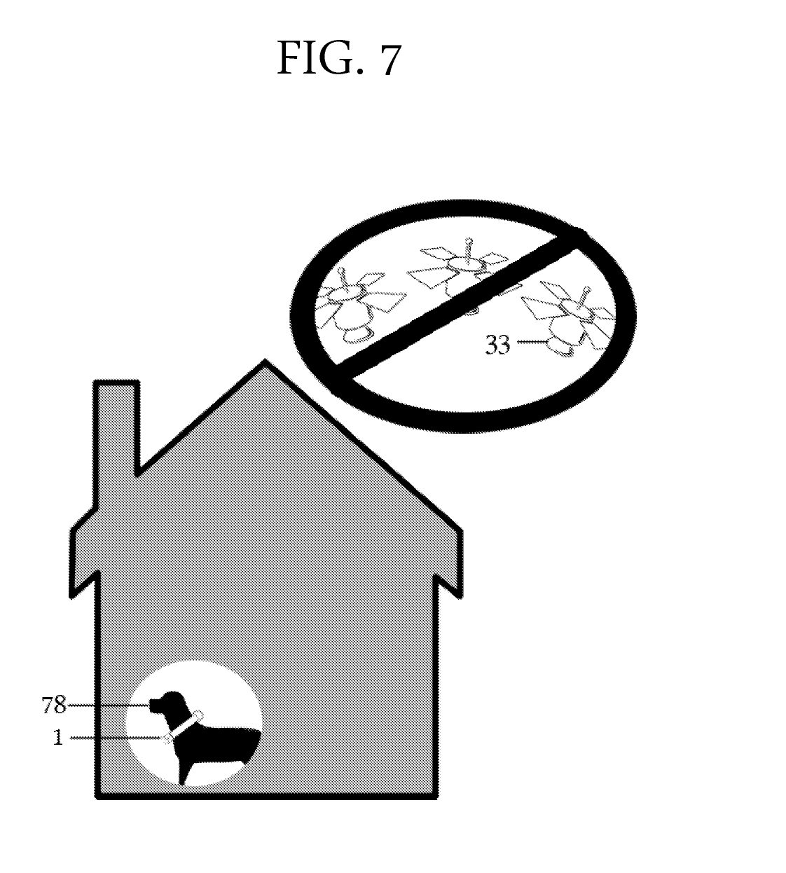

The FC 1 is illustrated as being worn by and recording activity levels of a pet 78 in FIG. 6A and 7. In FIG. 7, the FC 1 is tracking the activities of the pet 78 at a basic level through the use of the 3^{rd} electronic means for tracking BM, which can always be on, to track movement even when the existing GPS 33 is inaccessible. FIG. 6A illustrates the case when the existing GPS 33 is accessible and therefore provides a more accurate depiction of a pet's 78 movement pathway 82 relative to the basic level movement (e.g., as shown in FIG. 7). The FC 1 is programmed so that the 3^{rd} electronic means for tracking BM, which is connected to the Brain, logs the activity to the Storage until a time when the owner 77 can synchronize the metrics from the FC 1 to their PLU 2 by use of the APP 29. In FIG. 6A, the FC 1 is depicted as tracking the accurate activities of the pet 78 at a more precise level through the use of the 3^{rd} electronic means for tracking BM as well as the 1^{st} electronic means to determine the LOCI, which can be activated and de-activated by the owner 77 from the PLU's 2 APP 29. When activated, the 1^{st} electronic means allows the FC 1 to communicate 36 with the existing GPS 33, which allows the 1^{st} electronic means within the FC/FCA to utilize the FC's 1 Brain for logging activity to the Storage until a time when the owner 77 can WC 24 to synchronize the metrics from the FC 1 to the PLU 2 by use of the APP 29. This allows for the aforementioned accurate depiction of the pet's 78 movement pathway 82, which can be displayed through the APP 29 on an owner's 78 PLU 2, as shown in FIG. 6B.

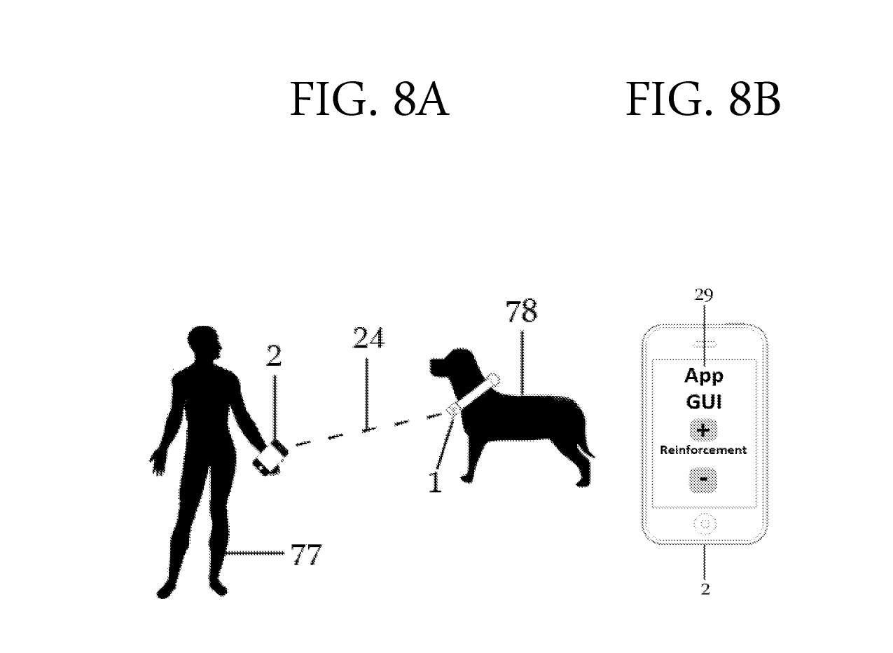

FIG. 8A depicts an owner 77 creating a sustained WC 24 between the PLU 2 and the FC 1 through the use of the 4^{th} electronic means 14 (e.g., see component 14 shown in FIG. 1A) in the FC 1 and the 5^{th} electronic means 83 (e.g., the 5^{th} electronic means is internal to the PLU 2 as indicated by the dotted box component 83 shown in FIG. 3B) in the PLU 2. Once this sustained WC 24 is made, the owner 77 can use the functions within the PLU 2 APP 29 GUI, such as to activate either/both positive and/or negatively reinforcing cue(s), meaning a signal that the owner has trained their pet to interpret as either positive or negative feedback to praise or correct their current actions, respectively, through the APP 29 to the pet 78 (a close-up view of the PLU 2 is shown in FIG. 8B). The FC 1 will utilize the Speaker 11 (e.g., see component 11 shown in FIG. 1A) to deliver audible cue(s) to the pet 78. The owner 77 should find the positive and negative frequency outputs that their pet 78 respond to and train them accordingly. The Storage 12 on the FC 1 (e.g., as shown in FIG. 1A) will track metrics pertaining to how often each type of cue is used as well as the length of time the owner 77 spends interacting with the pet 78, which could be invaluable data to an owner 77 interested in tracking their progress through training

### Additional Functionality of the FC:

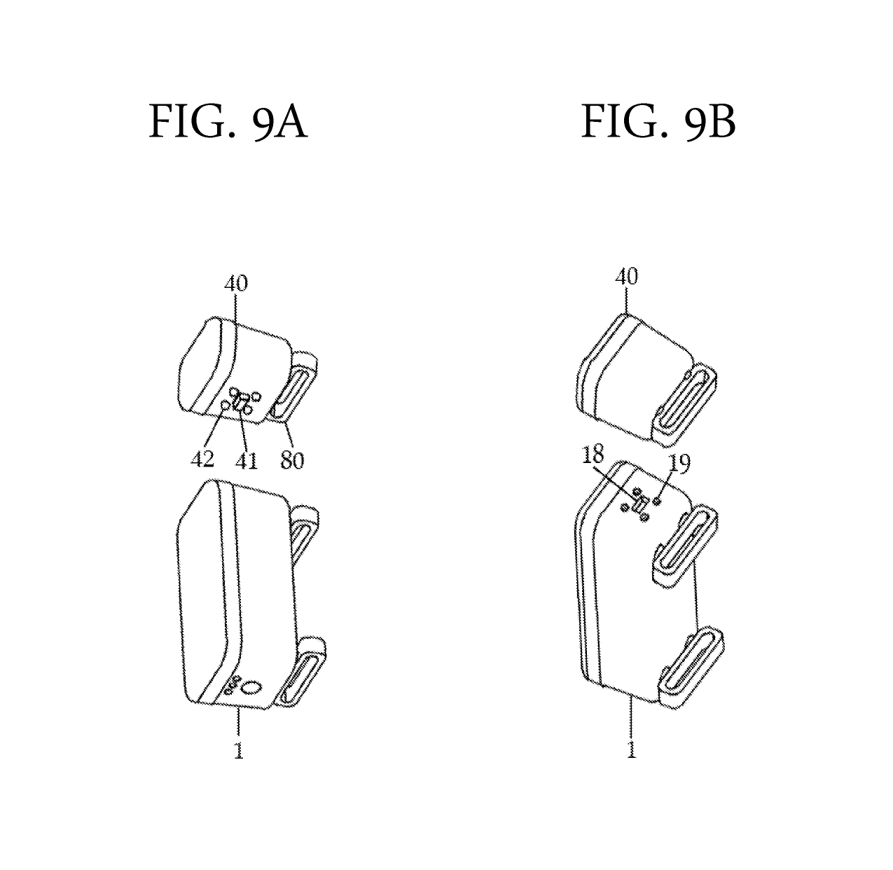

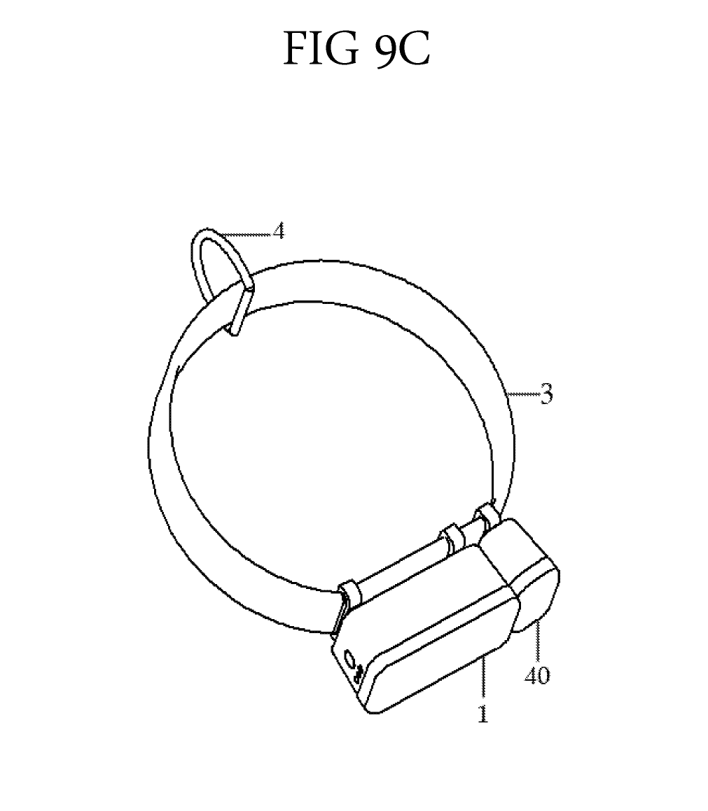

FIG. 9A through 15C illustrate some examples of accessory add-ons that could be made available in order to track additionally useful metrics, or assist with the monitoring and reinforcement of health, training and activity of pets.

Apart from the FC as presented herein, the FC will also have the capability for the owner to attach one or more additional accessory add-ons that will piggyback on the FC/FCA 1 to provide additionally useful metrics and/or assist with training and health activity tracking as shown in FIG. 9A through 15C as described herein.

FIG. 9A and 9B demonstrate an example of connecting a generic accessory add-on 40 to the FC 1. Details of specific types of accessory add-ons are described in subsequent paragraphs. The FCA 1, contains a Port 18 and female accessory attachment interface 19 which an accessory add-on 40 can connect to. The accessory add-on 40 possesses a male accessory communication port 41 to plug into the Port 18 and male attachment interface 42 that creates a secure attachment with the female accessory attachment interface 19 on the FC/FCA 1 and an attachment means 80 that would secure the accessory add-on to an included and/or standard/off-the-shelf collar. FIG. 9A and 9B demonstrate an example of the FCA 1 connecting to an accessory add-on 40, although there could be other methods such as by a tether/cable that plugs into the Port 18. The FC 1 and accessories will connect in a manner that would maintain the water/dust resistant nature of the device. Additionally, FIG. 9C depicts an FCA 1 interfaced with an accessory add-on 40 attached to a standard/off-the-shelf pet collar 3 with leash attachment 4.

### Some Examples of Specific Types of Accessory Add-Ons Can Include:

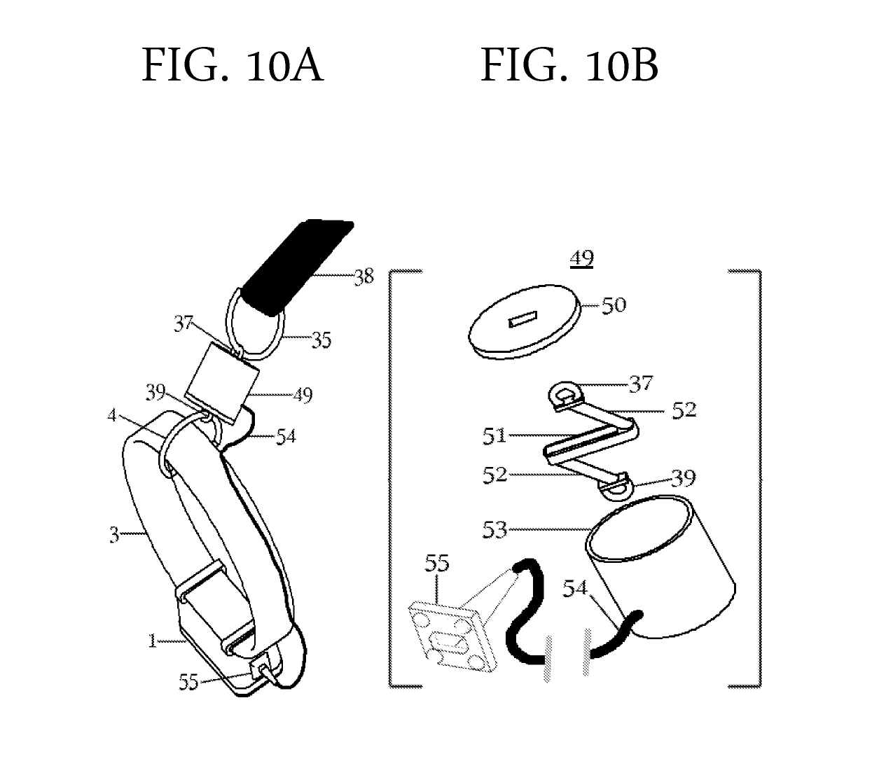

FIG. 10A and 10B demonstrate a tension leash trainer (“TLT”, 49) accessory add-on. As shown as an exploded view in FIG. 10B, the TLT 49 will contain a flex-type sensor 51 with arms 52 affixed to each end. One of those arms 52 will be connected to a loop 37 that will interface with the hook 35 on a standard/off-the-shelf leash 38, and the other arm 52 will be connected to a hook 39 that will interface with the loop 4 on a standard/off-the-shelf pet collar 3. These components will be housed in a bottom case 53 and cover 50 to maintain a water/dust resistant seal. The TLT 49 is shown in FIG. 10A as an example accessory add-on that connects to the FCA 1 with the male accessory communication port plug 55 on the end of a cable 54 which can be plugged into the Port 18 (e.g., as shown in FIG. 1A) via a male attachment interface of plug 55 that creates a secure attachment with the female accessory attachment interface 19 (e.g., as shown in FIG. 1A) on the FCA 1. The flex type sensor 51 inside the bottom case 53 of the TLT 49 will be set up in a manner that would allow the TLT 49 to detect and record the amount of tension that the pet is currently applying against the pet leash 38 at any given time during indoor/outdoor activity that would require a pet to be constrained. Once the tension detected by the TLT 49 surpasses a preset threshold, the FC 1 will automatically provide corrective feedback/cues to the pet. The APP running on the owner's PLU will allow the owner the capability of adjusting the level of tension allowed before a corrective response is activated on the fly, so that as the pet learns and becomes accustomed to the FC 1 issuing corrective feedback/cues at a specified tension level, the owner can reduce the tension threshold so that the pet will be allotted less tension before corrective feedback is issued. Over time, the owner can continually decrease the allowed tension until achieving the ideal level of leash tension for walks. Since the FC 1 also has the ability to record LOCI metrics, the owner would be able to detect patterns of leash tension based on exact LOCI metrics and recorded tension. For example, if the FC 1 metrics noted a TLT 49 activation every time their pet passes by a specific house of another pet or specific store, the owner could utilize these metrics and choose a better walking route that avoids these potential triggers.

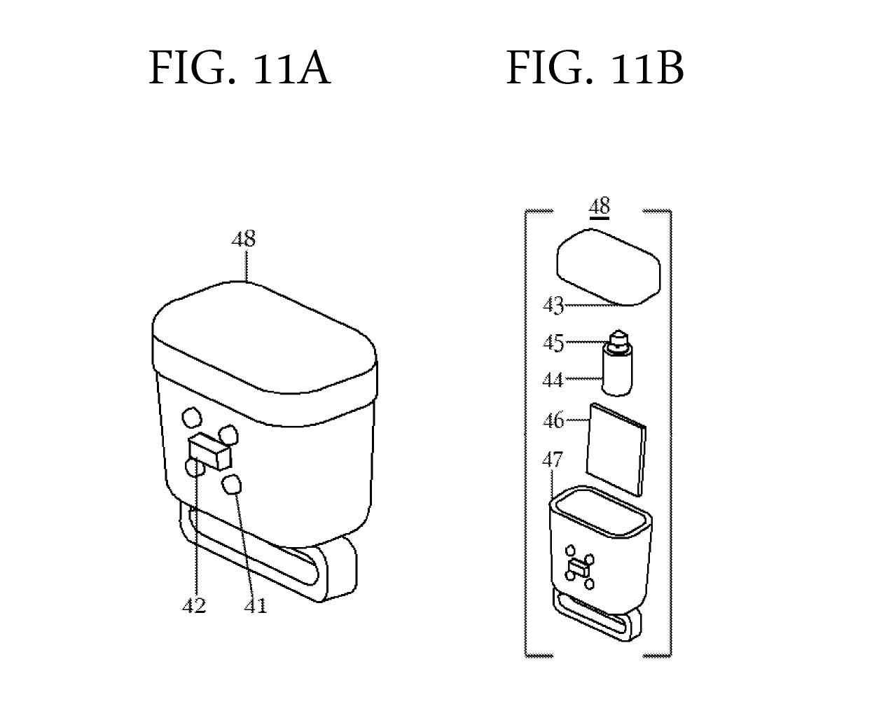

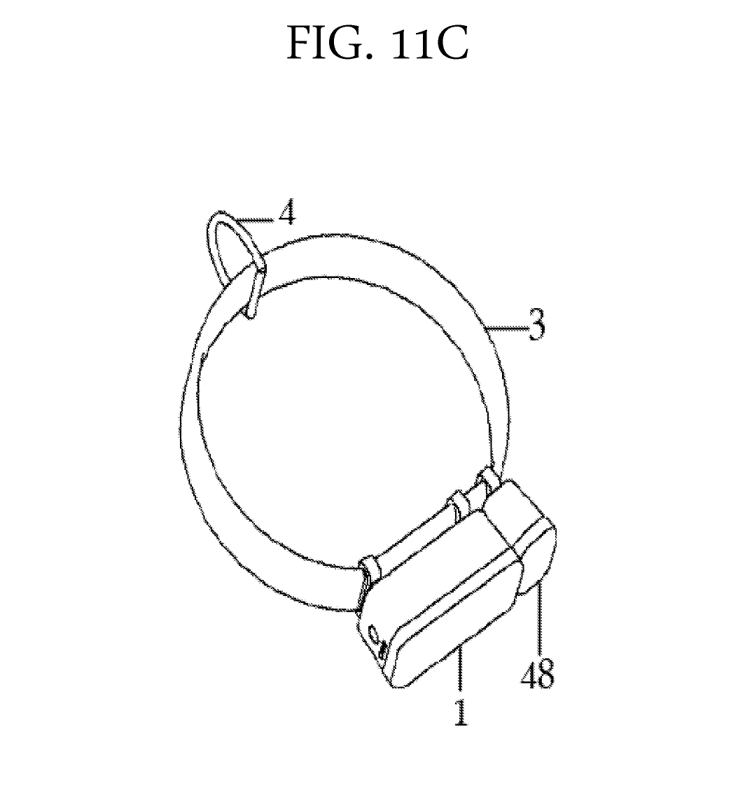

FIG. 11A through 11C illustrate an accessory add-on providing vibration feedback (“VIB”, 48). Prior art has utilized vibration feedback as an additional means of issuing positive and/or negative feedback cues to pets. In a similar fashion, the VIB 48 as shown in FIG. 11A will provide the FC will the capability of adding vibration means of feedback. FIG. 11B is an exploded view of the VIB 48, which will contain a circuit board 46 that has the necessary components to power a small motor 44 connected to an off-balance weight 45 sealed inside a bottom case 47 and accessory cover 43. As demonstrated in FIG. 11C, the VIB 48 will connect to the FC/FCA 1 with the male accessory communication port 41 (e.g., as shown in FIG. 11A) which plugs into the Port 18 (e.g., as shown in FIG. 1A) and male attachment interface 42 (e.g., as shown in FIG. 11A) that creates a secure attachment with the female accessory attachment interface 19 (e.g., as shown in FIG. 1A) on the FC/FCA 1 in a manner that allows both to interface with a standard/off-the-shelf pet collar 3 shown with leash attachment 4. In instances where a pet is either hard of hearing, deaf, or merely unresponsive to audible commands, the VIB 48 could also be utilized as a means for an owner to merely obtain a pet's attention and/or provide positive/negative feedback.

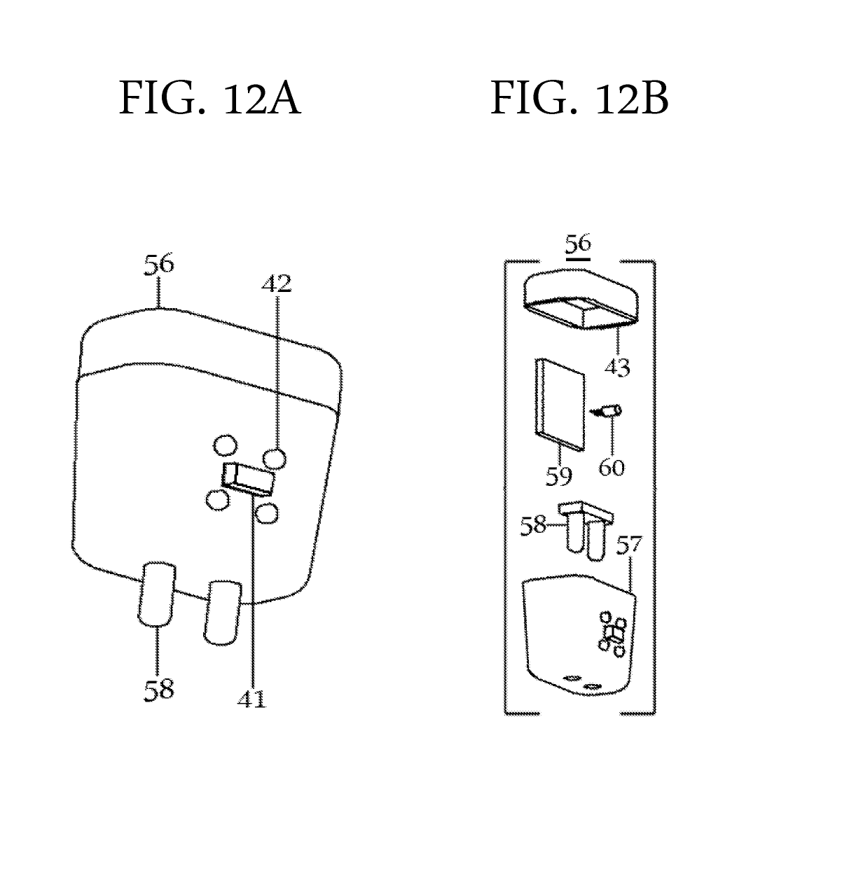

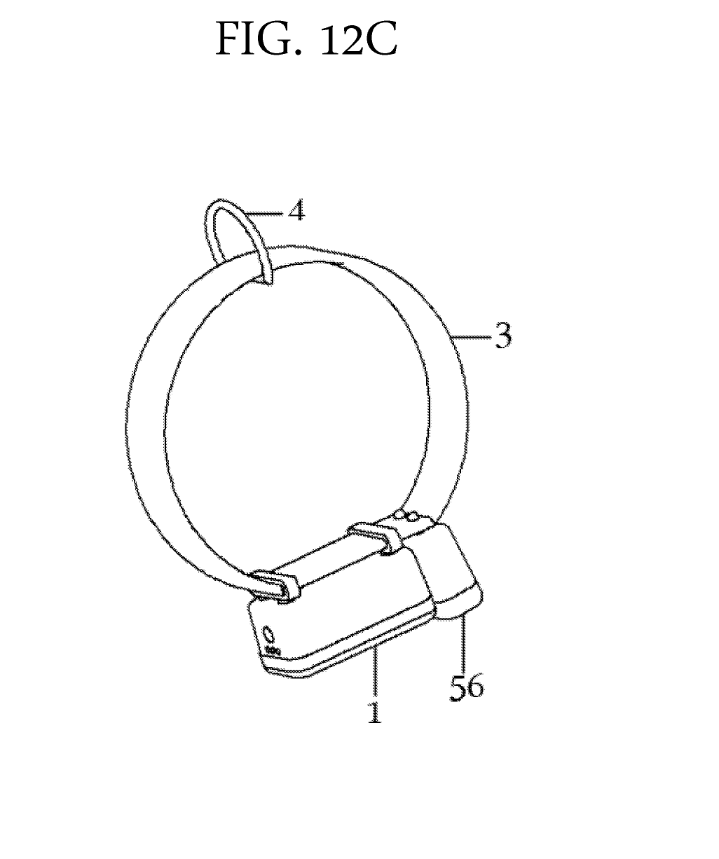

FIG. 12A through 12C illustrate an accessory add-on (“Shock”, 56) providing electrical shock feedback. Prior art has utilized shock feedback as an additional means of issuing positive/negative feedback cues to pets. In a similar fashion, the Shock 56 as shown in FIG. 12A will provide the FC/FCA 1 with the capability of having electrical shock as a means of feedback. FIG. 12B is an exploded view of the Shock 56, which will contain a circuit board 59 that has the necessary components to charge a small capacitor 60 which will dispense a small electrical shock to the pet through the shock terminals 58 which would be placed in a way that they come in contact with the pet's body. These components would be sealed inside a bottom case 57 containing holes for the shock terminals to protrude 58 through and accessory cover 43. As demonstrated in FIG. 12C, the Shock 56 will connect to the FC/FCA 1 with the male accessory communication port 41 (e.g., as shown in FIG. 12A) which plugs into the Port 18 (e.g., as shown in FIG. 1A) and male attachment interface 42 (e.g., as shown in FIG. 12A) that creates a secure attachment with the female accessory attachment interface 19 (e.g., as shown in FIG. 1A) on the FC/FCA 1 in a manner that allows both to interface with a standard/off-the-shelf pet collar 3 shown with leash attachment 4. In instances where an elevated level of correction is necessary, or for pets that do not respond well to audible cues, the Shock 56 will provide a more intense method of feedback/cue functionality to be utilized by the owner.

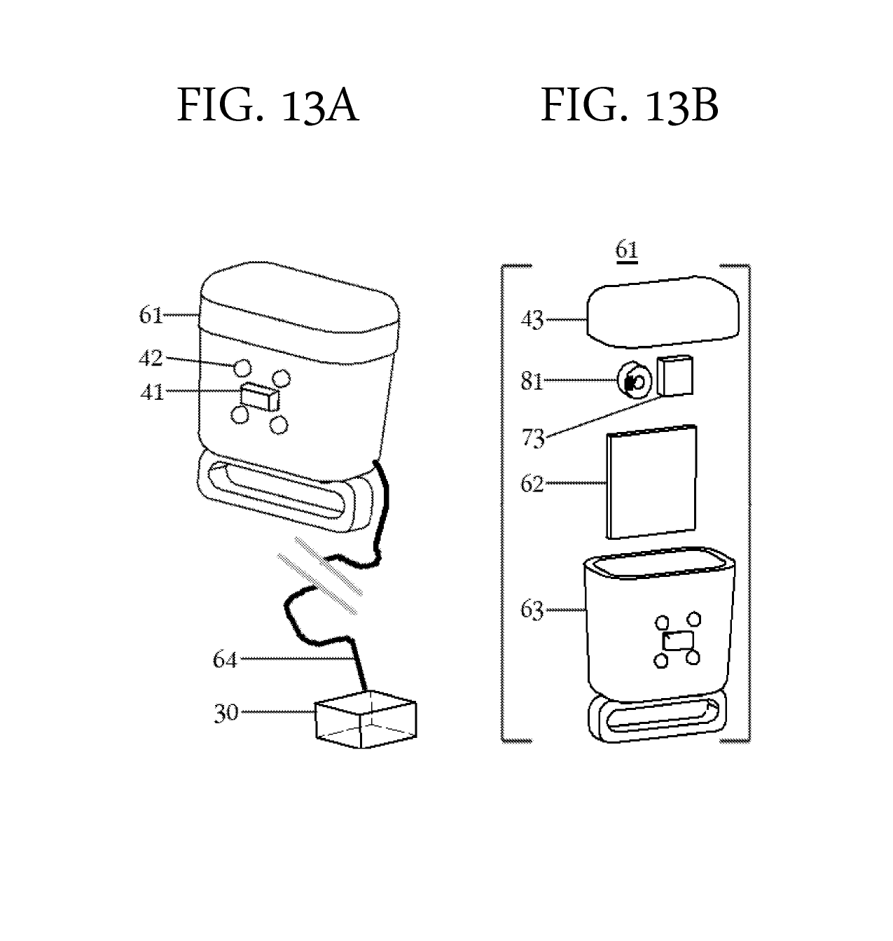

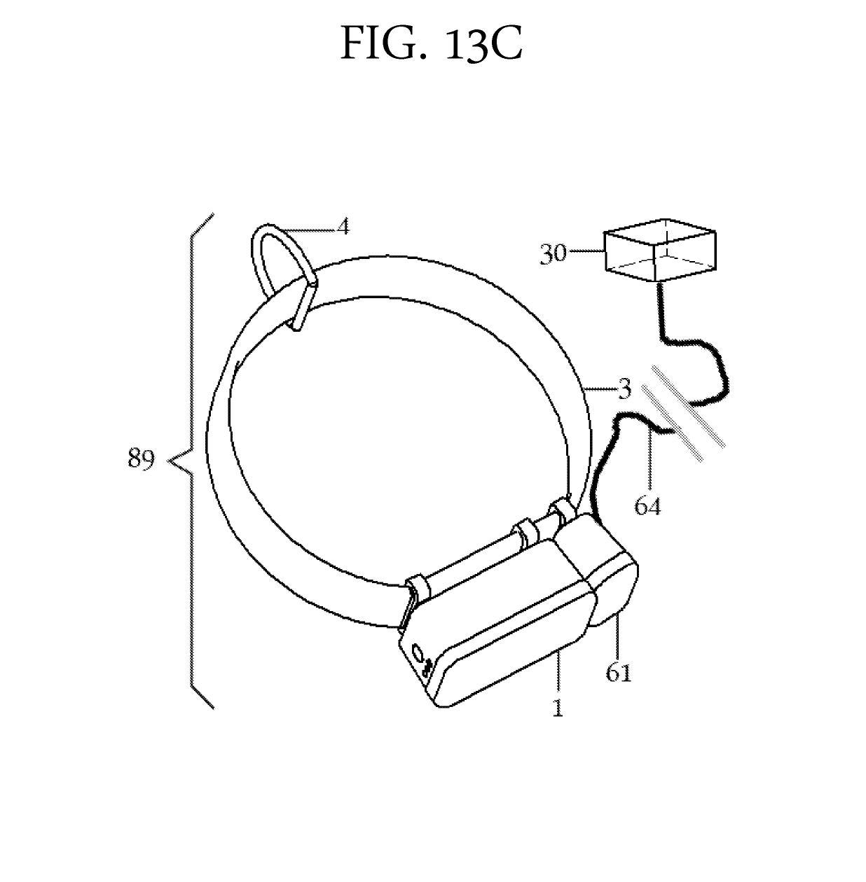

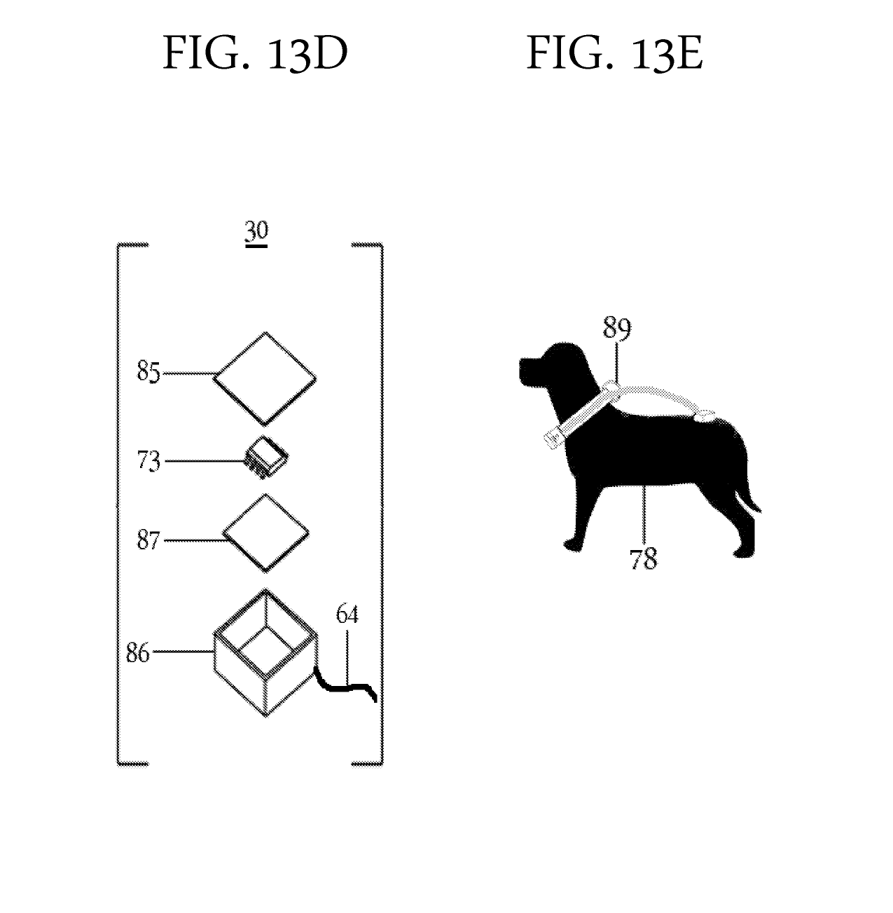

FIG. 13A through 13E illustrate an accessory add-on (“TH”, 61) that would act as a training helper. The TH 61 as shown in FIG. 13A could be used alone or with one or more secondary training sensors 30 and accompanying cable(s) 64 each of which would be capable of detecting intricate movement in multiple-dimensions as well as a familiarity of the movement between the TH 61 and the one or more secondary training sensors 30 in relation to each other. FIG. 13B is an exploded view of the TH 61, which will contain a circuit board 62 that has the necessary components to record the movement patterns of a gyro-type sensor 73 and operate a microphone 81 which would all be sealed inside a bottom case 63 which contains a means of connecting the cable 64 from the secondary training sensors 30 and a top accessory cover 43. FIG. 13D demonstrates an exploded view of the secondary training sensor 30, which will also contain a circuit board 87 and necessary components to record the movement patterns of a gyro-type sensor 73, sealed by a top cover 85 and contained in a bottom case 86 that allows for the cable 64 that connects to the TH 61 to feed through. Henceforward the TH 61 accompanied by zero or any number of secondary training sensor(s) 30 and accompanying cable(s) 64 will be referred to as the TH Unit (“THU”, 61/30/64). It is noted that the secondary training sensor(s) 30 and cable(s) 64 of the THU 61/30/64 can be easily integrated/fastened into a harness/jacket/vest or other device known in the art as a method of securing the sensor(s) 30 and cable(s) 64 throughout the THU 61/30/64 to the pet.

As shown in FIG. 13C, the THU 61/30/64 will connect to the FC 1 with the male accessory communication port 41 (e.g., as shown in FIG. 13A) which plugs into the Port 18 (e.g., as shown in FIG. 1A) and male attachment interface 42 (e.g., as shown in FIG. 13A) that creates a secure attachment with the female accessory attachment interface 19 (e.g., as shown in FIG. 1A) on the FC/FCA 1 in a manner that allows both to interface with a standard/off-the-shelf pet collar 3 shown with leash attachment 4 (the THU 61/30/64 and FC 1 attached to a standard/off-the-shelf pet collar 3 with leash attachment 4 are represented as one unit and henceforward referred to as THU/FC 89). To achieve better readings with the THU/FC 89, the secondary training sensors will be attached to the pet 78 in multiple locations such as above the rear legs as demonstrated in FIG. 13E. The owner would be able to utilize functionality within the APP through their PLU that could display the metrics recorded by the THU/FC 89 as the pet is asked to perform specific training actions.

In practice, the FC 1 will be recording the movement patterns sensed by the THU 61/30/64 and recorded by the FC 1 for each specific training action and detect the patterns' accuracy within a given threshold of error against previous iterations of the movement recorded when performing the same training action. The owner could then choose a training action request that they are asking their pet 78 to complete from the APP on their PLU, at which point they would also provide the pet 78 with their audible/visual cue associated with that training action. The FC 1 would then expect the THU 61/30/64 to record an instance of that memorized movement pattern within an amount of time deemed reasonable by the owner, and automatically provide positive/negative feedback to the pet 78 depending on the metrics recorded. The THU 61/30/64 also contains a microphone 81 that would record the owner's audible training action request along with the movement patterns of the THU 61/30/64 and zero or more secondary training sensors 30 providing an even more automated result. When the owner is using audible cues, the THU 61/30/64 would “Hear” the cue through the microphone 81 and automatically expect the movement pattern without the owner needing to indicate the training action through the APP on their PLU. The data recorded by the FC 1 when utilizing the THU 61/30/64 would provide numerous additional metrics which could be tracked and integrated into the Website/SEPCS network. Additionally, if the owner is teaching their pet 78 a new training action, the THU/FC 35 could be programmed to automatically provide the pet positive feedback even in the absence of the owner to help reinforce the new behavior. Conversely, if the owner is attempting to stop specific actions (e.g., jumping, humping), the THU/FC 35 could automatically issue negative feedback when there are recorded instances of these actions.

Another potential use for the THU 61/30/64 would be training a pet 78 to provide owner's with information based on the pet's 78 current needs. For example, if an owner trained a pet 78 to perform a certain gesture or move into a certain position such as based on LOCI when they needed something, the FC 1 could communicate that need with the PLU. Example uses could be training the pet 78 to sit near the door when they need to go outside, by the water/food dish when it is empty, or similar. When these actions are completed, the owner's PLU would receive an alert through the APP of the pet's 78 request.

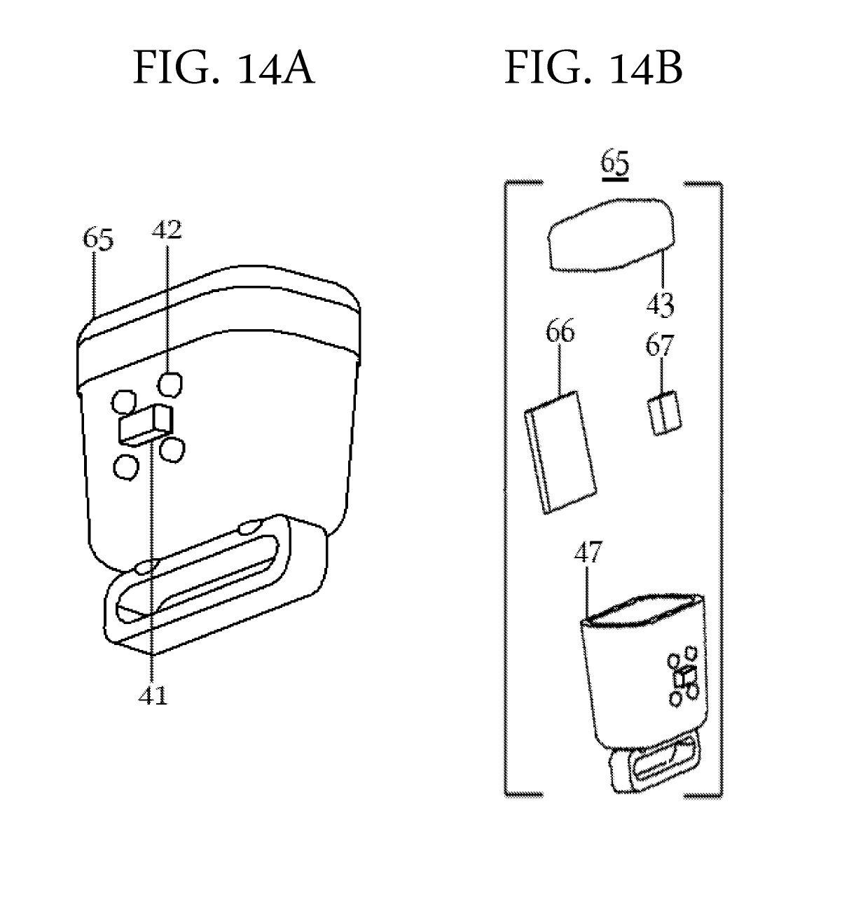

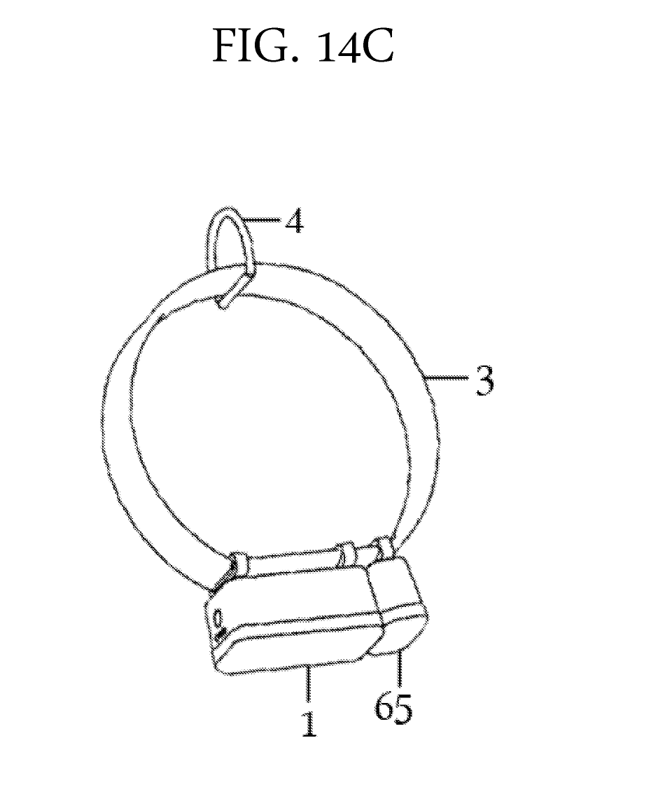

FIG. 14A through 14C illustrate a wireless leash (“WL”, 65) accessory add-on. The WL 65 as shown in FIG. 14A will provide the capability of an owner controlling their pet from afar as if they were on a wireless leash. FIG. 14B demonstrates an exploded view of the WL 65, which will contain a circuit board 66 that has the necessary components to operate a component 67 capable of longer distance sustained communication (e.g., Bluetooth capable of a ˜350 foot range or Wireless Fidelity adapter) between the FC 1 and PLU. These components will be sealed inside a bottom case 47 and accessory cover 43. As demonstrated in FIG. 14C, the WL 65 will connect to the FC/FCA 1 with the male accessory communication port 41 (e.g., as shown in FIG. 14A) which plugs into the Port 18 (e.g., as shown in FIG. 1A) and male attachment interface 42 (e.g., as shown in FIG. 14A) that creates a secure attachment with the female accessory attachment interface 19 (e.g., as shown in FIG. 1A) on the FC 1 in a manner that allows both to interface with a standard/off-the-shelf pet collar 3 shown with leash attachment 4. The APP on the owner's PLU could allow the owner to set a given radius within which the pet can travel from the PLU without any corrective feedback being issued based on the LOCI and LOC2 data logged by the FC 1 and PLU, respectively. Once a pet travels close to or outside of that radius, they will receive corrective feedback cue(s) to return closer to the owner's PLU. Additionally, given the proper wide area network to maintain constant WC with the FC 1 and within jurisdiction of local laws, the owner could predetermine a narrow designated path on which their pet could travel in order to allow the pet to walk itself

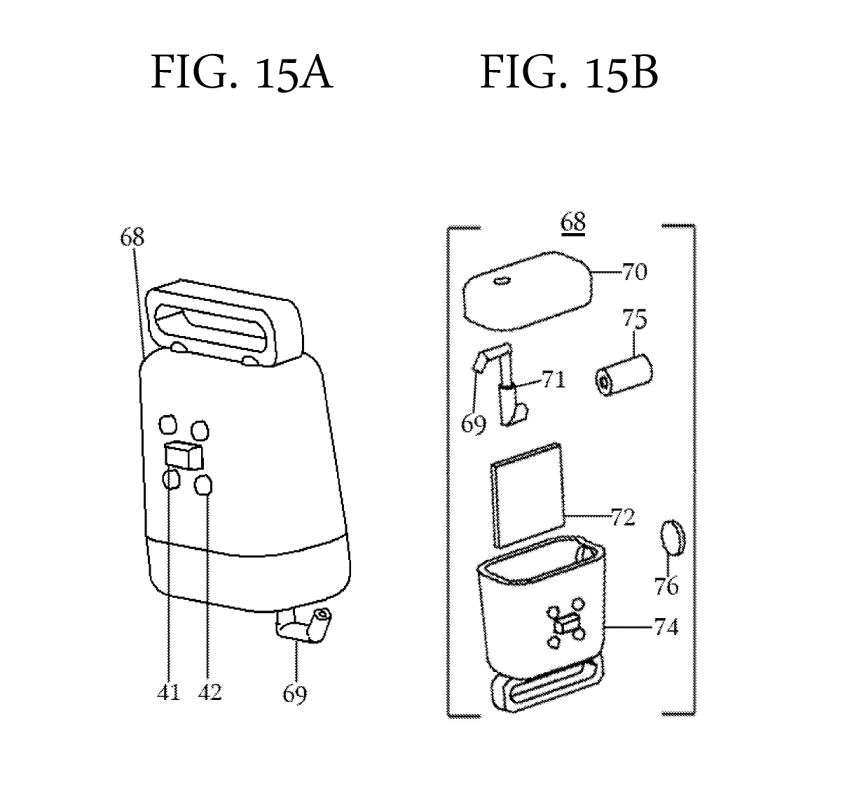

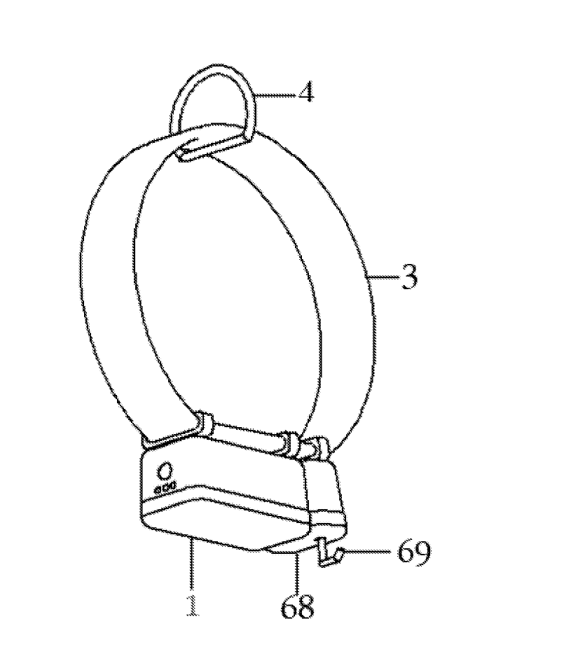

FIG. 15A through 15C demonstrate a pheromone and/or other positive or negatively correcting sprayer (“Sprayer”, 68) accessory add-on. The Sprayer 68 as shown in FIG. 15A, and an exploded view in FIG. 15B will contain a circuit board 72 that has the necessary components to operate a component 71 that interfaces with a disposable spray cartridge 75. The components would all be sealed inside a bottom case 74 that has an opening to swap disposable cartridges 75 and a lid/seal 76 to cover the open. There will be a top accessory cover 70 that contains a hole through which the nozzle 69 can protrude. As demonstrated in FIG. 15C, the Sprayer 68 will connect to the FC/FCA 1 with the male accessory communication port 41 (e.g., as shown in FIG. 15A) which plugs into the Port 18 (e.g., as shown in FIG. 1A) and male attachment interface 42 (e.g., as shown in FIG. 15A) that creates a secure attachment with the female accessory attachment interface 19 (e.g., as shown in FIG. 1A) on the FC 1 in a manner that allows both to interface with a standard/off-the-shelf pet collar 3 shown with leash attachment 4. The Sprayer 68 would be positioned in a way that the nozzle 69 can emit the product in the disposable spray cartridge 75 (e.g., as shown in FIG. 15B) into the vicinity of the face of the pet. The owner can utilize the pheromone or other spray to provide positive/negative feedback or calming effect to a pet through a remote activation directly from the PLU. This could be used for pets that require an additional method of feedback for training purposes. In the instance of utilization as a pheromone sprayer, the Sprayer 68 could be used for pets that require calming or easing of their nerves based on situational needs (thunderstorms, entering large crowds, etc.). The APP on the PLU could enable owners to activate the Sprayer 68 on-the-fly, at set intervals, or use it in the same method as other feedback cues. Another way the Sprayer 68 could be enabled/disabled would be utilizing metrics recorded by the FC 1 to detect instances that may require automatic disbursing of pheromones and/or positive/negative cues.

### Other Potential Embodiments

Aside from or along with the preferred embodiment described herein, the following are instances in which the FC/PLU and recorded metrics could be utilized to assist current professionals who have a third party interest in the owners pets.

### Trainers:

Traditional pet training usually includes a 6-8 week course in which an owner will bring their pet in to a trainer's facility once per week for a short amount of time, such as 1-2 hours. The only information trainers currently have between those sessions is the word of mouth information that the owner provides related to how often they have interacted with their pet, be it: walking them, providing specific care to them, or practicing the training skills learned in class. The FC could be issued (rented/sold/provided) by a dog trainer who would be provided administrative access to the metrics recorded by the FC related to pets within their class. This could provide them with real feedback related to the pet's activity levels, how often and how far they were walked, how often and how long owners worked with the pet on their training skills as well as the pet's progress learning the skills based on instances the owner provided positive and/or negative feedback during training Utilizing the SEPCS Network, trainers could provide recommended schedules for regular training and walking time for their owner(s) and their pet(s) (“client(s)”). Based on the success of the owner and pet interactions from the weekly training class coupled with each pet's metrics, the trainer could tweak recommendations for future weeks. Also, training recommendations could be changed on-the-fly based on current weather conditions of the area. This embodiment would create accountability for pet owners to assure they are progressing in training and getting their money's worth because the trainer has access to the metrics acquired via the SEPCS Network. If fully integrated into a trainer's class, it would also provide the owner insight in order to become familiar with PLU/FC interactions and functionality.

### Veterinarians:

Veterinary offices will usually recommend twice-yearly check-ups to ensure pets are in good health. If veterinary doctors rent/sell/provide FC/FCAs to their client(s), the veterinarian would have constant access to the pet's health through metrics. This would be invaluable information for a vet to see a true picture of a pet's day-to-day health, and would give the vet the opportunity to make more informed health decisions. Vet offices could allow discounts to owner's who rent/buy/use the FC/FCAs and allows the vet access to pet metrics via the SEPCS Network. For example, some vet offices offer pet wellness plans, which have a monthly set fee that covers all of the pet's routine check-up costs at a discounted rate vs. what those costs would be on a per-visit basis (an example is Banfield Pet Hospital). If a vet office marketed the FC to owners subscribing to their wellness plans, they may provide owners with discounts on their monthly dues since the vet would be able to have a very accurate picture of the pet's health. As long as the owner keeps their pet's health metrics within a minimum specified range as established by the vet through the SEPCS Network, then the owner would be able to maintain a monthly fee discount.

While preferred embodiment(s) of the invention has been described using specific terms, such description is for illustrative purposes only, and it is to be understood that changes and variations may be made (e.g., utilizing induction charging; video camera that is/could be bark activated; and/or optical sensor(s) for additional metrics such as blood pressure, body temperature, emotional state; stacking multiple accessory add-ons; pairing an accessory add-on with a portable radio or other signal broadcaster for close-range remote pet fencing; coupling pertinent Metrics input data to create a method for dogs to “speak” audibly through the FC) without departing from the spirit or scope of the following claims.

We claim:

1. A system that tracks and logs the position and movement of a plurality of feedback collars for the purpose of sharing information among owners related to the health, activity levels, movement path and location of pets, which contains in combination:
a plurality of feedback collars;
a primary logging unit electronically coupled to a graphical user interface through which an owner can interact;
a 1^{st} electronic means that determines the 1^{st} location of one or more of the plurality of feedback collars;
a 2^{nd} electronic means that determines the 2^{nd} location of the primary logging unit;
a 3^{rd} electronic means to determine the basic movement of one or more of the plurality of feedback collars;
a 4^{th} electronic means to create a wireless communication link from a feedback collar to one or more other feedback collars or one or more primary logging units;
a 5^{th} electronic means to create a wireless communication link from a primary logging unit to one or more feedback collars or one or more other primary logging units;
a 6^{th} electronic means that acts as a processing unit that will enable the components of the feedback collar to interact with each other within a given feedback collar as well as with other feedback collars and primary logging units within the smart electronic pet collar system;
a 7^{th} electronic means for storing logged data on one or more of the plurality of feedback collars prior to the feedback collar syncing the logged data with the primary logging unit;
and, an 8^{th} electronic means for storing all history of logged data on the primary logging unit.

2. The system of claim 1 wherein the system enables an owner to selectively encrypt data shared with another owner or owners.

3. The system of claim 1 wherein the 1^{st} location is determined via a GPS chipset.

4. The system of claim 1 wherein the 1^{st} electronic means records a history of data to determine the movement path of one or more feedback collars via a GPS chipset.

5. The system of claim 1 wherein the 2^{nd} electronic means determines the location of one or more primary logging units via a GPS chipset.

6. The system of claim 1 further comprising a method wherein the 3^{rd} electronic means determines the basic movement of one or more feedback collars via an accelerometer or pedometer-like sensor.

7. The system of claim 1 further comprising a method to wirelessly transmit and share information between feedback collars and primary logging units based on the 1^{st} location and 2^{nd} location of said units determined by the 1^{st} electronic means and 2^{nd} electronic means, respectively.

8. The system of claim 1 further comprising a primary logging unit that enables each owner to selectively grant permission to acquire and share logged pet data stored on the respective owner's primary logging unit with at least one or more other owners utilizing their primary logging units.

9. The system of claim 1 wherein in the plurality of feedback collars additionally comprise a speaker to provide audible commands and feedback to the owner and pets.

10. The system of claim 1 wherein in the plurality of feedback collars additionally comprises one or more LED lights to provide information related to the state of the feedback collar.

11. The system of claim 1 wherein in the plurality of feedback collars additionally comprises a power supply to provide power to all components included within the feedback collar.

12. The system of claim 1 wherein in the plurality of feedback collars additionally comprises a button to interact with the functionality of the feedback collar.

13. The system of claim 1 wherein said feedback collar is attached to and carried by a standard/off-the-shelf collar worn around the neck of a pet.

14. The system of claim 1 wherein the primary logging unit is an owner's smartphone, tablet, PDA, other similar mobile device, or, in lieu of an owner possessing said mobile device, their personal computer will act as a primary logging unit.

15. The system of claim 1 comprising a wireless communication connection to transmit data and provide interaction between one or more primary logging units and one or more plurality of feedback collars.

16. The system of claim 15, wherein the wireless communication is enabled by the 4^{th} electronic means contained in one or more feedback collars and the 5^{th} electronic means contained in one or more primary logging units.

17. The system of claim 15, wherein the wireless communication connections utilize Bluetooth radio(s).
